(19) United States
(12) Patent Application Publication
(10) Pub. No.: US 2007/0208737 A1
(43) Pub. Date: Sep. 6, 2007

(54) Cache Server Network And Method Of Scheduling The Distribution Of Content Files Within The Same

(76) Inventors: Jun Li, Plainsboro, NJ (US); Junbiao Zhang, Bridgewater, NJ (US); Snigdha Verma, Somerset, NJ (US)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(21) Appl. No.: 10/592,345

(22) PCT Filed: Mar. 12, 2004
(86) PCT No.: PCT/US04/07652

§ 371 Date: Sep. 11, 2006

(51) Int. Cl. G06F 17/30

(52) U.S. Cl. 707/6

(57) ABSTRACT

A technique for scheduling distribution of a content file within a content delivery network and a content delivery network adapted to perform the same are disclosed. The technique comprise scheduling distribution of the content file based on delivery location, service time of content requests, and cache server hierarchy. Preferably, a multicasting tree for delivering each content file is dynamically established in the content delivery network based on location and service time considerations.

### FIELD OF THE INVENTION

The present invention relates generally to the field of data communication and cache server networks, and specifically to systems and methods for scheduling multicasting distribution of content files within content delivery networks.

### BACKGROUND OF THE INVENTION

For large size content, such as movies, content clients usually can tolerate some delay in exchange for better quality. A client may rather watch a high quality downloaded video at a future scheduled time than view a low quality streaming video instantaneously. For example, a mobile user can order a video in advance while he/she is in a cellular mobile network and download it at a later time while he/she is in a hotspot wireless LAN. This is known as a remote site downloading. As such, the mobile user can enjoy a high quality content at low cost.

In recent years, the use of content delivery network (CDN) technology has spread to the Internet to improve the downloading of web pages. A content delivery network (CDN) consists of cache servers at different geographic locations, i.e., network nodes with storage and transport capabilities. The basic premise of CDN technology is that the link between the cache server and the client has low cost and high bandwidth. If at the time a client requests a content file, the content file is stored in the cache of a nearby cache server, the downloading will be fast. Otherwise, the client may experience a longer delay. Thus, it is preferable for a client to download the content file from the most nearby cache server. The technology of finding the nearby cache server for a client is called request-routing. It is a procedure of redirecting a content request to a closer cache server. For example, modifying a URL from the original URL to a URL prefixed by the cache server. In another application of us, an extension of conventional request-routing with content timing is provided to redirect a request to a closer cache server based on the future availability of the requested content on the cache server.

Typically, a client can tolerate a delay for a large size content file up to the expected service time which the client designates as the time he/she wishes to retrieve the content file. Thus, even if the requested content file is not currently stored in a cache server close to the client, so long as the downloading system transfers the content file to the cache server prior to the expected service time, the client will not experience a delay. It is a goal of the industry to reduce these delays by properly scheduling the downloading of requested content files to the appropriate cache server for client retrieval.

Multicasting content delivery can be requested at different cache servers. Due to the availability of advanced content request information before content downloading, it is possible to optimize content distribution in a CDN through multicasting technologies. Typically, a downloading service requires a CDN to provide distribution of a content file to the cache server closest to where the client request for that content file is coming from. The content file must be stored on that cache server and ready for downloading to the client at a time no later than the expected service time designated by the client. As such, a need exists for improved systems and methods for scheduling the distribution of a content file to cache servers associated with requests for that content file.

### DISCLOSURE OF THE INVENTION

Briefly, the invention concerns a method for scheduling the distribution of a content file within a cached network environment. The method comprises the steps of: receiving a request for content to be delivered at a service time, associating the content file with a particular cache server, dynamically establishing a multicasting tree of cache servers and delivering the requested content at the service time from the multicasting tree of cache servers.

### BRIEF DESCRIPTION OF THE DRAWINGS

FIG. 1 is a schematic of a content delivery network according to one embodiment of the present invention.

FIG. 2 is a schematic of the content delivery network of FIG. 1 showing the downloading and association structure resulting from a number of user requests for a content file according to one embodiment of the present invention considering closeness of cache servers.

FIG. 3 is a flowchart diagram of a method of scheduling distribution and downloading of content files in a content delivery network according to one embodiment of the present invention considering closeness of cache servers.

### MODES FOR CARRYING OUT THE INVENTION

Multicasting distribution can be implemented at either the transport layer or the application layer. Because there are a number of deficiencies associated with transport layer multicasting, only application layer multicasting is considered for the present invention. Transport layer multicasting requires a multicasting enabled transport network. The Internet does not typically have such a transport network. Additionally, even if there is a multicasting enabled transport network available, the transmission on all the branches of a multicasting tree must be simultaneous. This may not be possible if any of the network nodes (i.e., the cache servers) on the multicasting tree do not have transport or cache capacity at any period of the multicasting session. However, application layer multicasting can be more flexible on the transmission schedule from node to node on a multicasting tree. For a downloading service that has many downloading requests at different expected service times, the application layer multicasting could be more suitable. As used herein, application layer multicasting is defined as a store/forward action at each network node on the multicasting tree. Store implies caching on intermediate nodes and forward means transmission to multiple ports at same or different time.

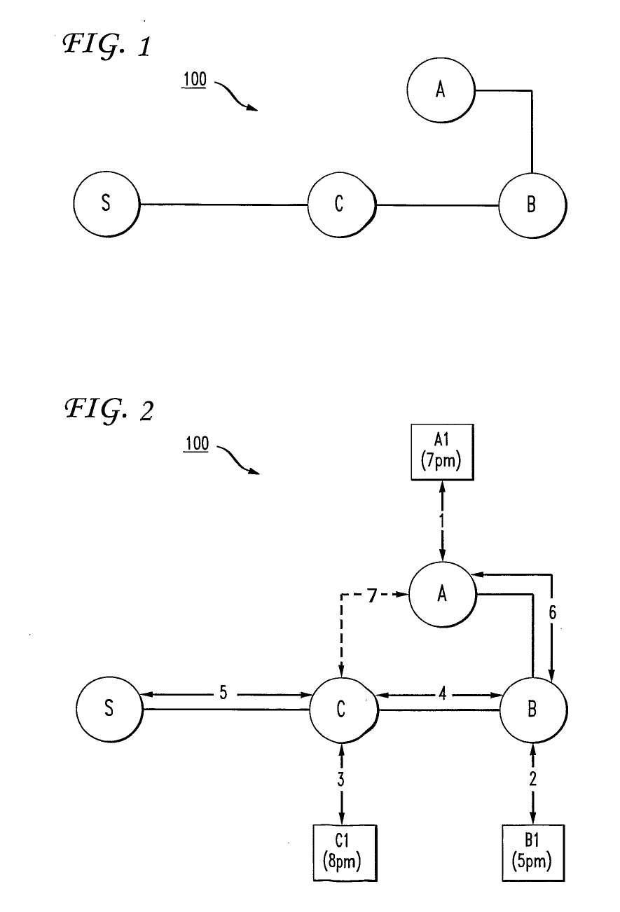

Referring now to FIG. 1, an embodiment of a content delivery system of the invention 100 is illustrated. System 100 comprises content server S, and a CDN comprising cache server A, cache server B, and cache server C. While a specific structure is illustrated for CDN with only three cache servers, the present invention is not limited to any particular network structure or configuration. Regardless of the structure of a CDN network (flat or hierarchical), a multicasting tree can be established for content file distribution according to the present invention. So long as requests for the same content file do not have the same expected service time, the downloading and association structure (i.e., the multicasting tree structure) will depend not only on the distances between source and destinations but also on the gaps between different expected service times.

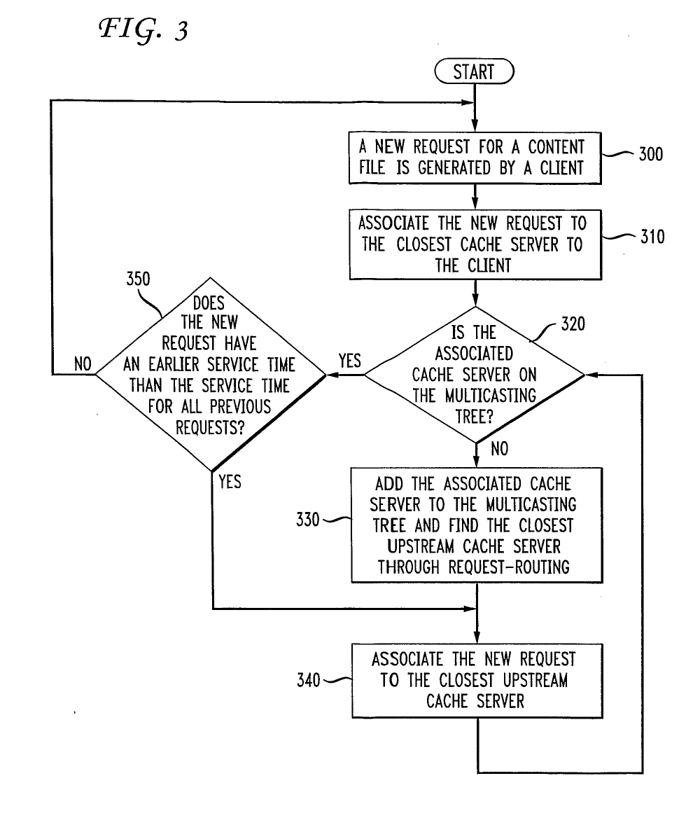

Referring now to FIG. 2, which illustrates content delivery system 100 with data flow arrows connecting the illustrated components, and FIG. 3, an embodiment of the method of the invention, at step 300, clients/users A1, B1, and C1 each generate a request for the same content file. Each request for the content file has an estimated service time. As used herein, the service time of a request is that time at which the client requests that the content file be available for downloading to the client's electronic device, be it a computer, a cell phone, or a personal data assistant. The service time is designated by clients A1, B1, and C1 when the request is made. In the example, the service times for the requests generated by clients A1, B1, and C1 are 7 PM, 5 PM, and 8 PM respectively. Despite the service times having a chronological order of B1-A1-C1, there is no limitation on the order in which the requests may have been generated by the clients and/or received by the system 100.

The requests generated by clients A1, B1, and C1 (which for simplification of understanding will be called requests A1, B1, and C1) are associated to cache server, A, B, C, respectively, completing step 310. The associations of the requests A1, B1, and C1 with cache server A, B, and C are designated by lines 1, 2, and 3 respectively in FIG. 2. The association decision is made by the CDN through either static hierarchical structure or dynamic request-routing process. The choice of which cache server each request is associated with is determined by the closeness of the cache server to the client. Preferably, a request is associated with the cache server that is closest to the client making the request for the content file. As used herein, closeness can be determined using physical locality and/or network locality taking into consideration bandwidth cost and/or congestion. Technology used to perform such associations is known as request-routing technology. The determination of which cache server to associate a request with can be learned statically, i.e., there is a pre-established hierarchical structure as in multi-proxy servers, or dynamically. Alternatively, the client can designate a specific cache server to which his/her request should be associated with, such as with remote site downloading function at hotspots.

When the association of a request to a cache server is dynamically determined by request-routing technology, extended request-routing technology should be used. E. In this case, even when the requested content file is currently not available on a cache server, the request-routing can still associate the request to that cache server because the association is meant to deliver the content file to that cache server at a future time.

Requests A1, B1 and C1 are sent to the content server S in the order of B1, C1 and A1. The multicasting tree will initially have only one node, content server S. Because request B1 is the first request sent to content server S, step 320 will be performed for cache server B first. At step 320, the determination is made whether the cache server B is on the multicasting tree. If the answer is NO (which it is in this case), the system adds node B to the multicasting tree and continues to step 330. At step 330, the system checks for the existence of a closest upstream cache server and, in this case, finds upstream cache server C. This is done through either static hierarchy or request-routing. Request routing is illustrated. Request B1 is then associated to the cache server C, completing step 340. The association of request B1 to cache server C is shown in FIG. 2 as line 4.

Step 320 is then performed for cache server C. According to step 320, it is then determined whether cache server C is on the multicasting tree. If the answer is NO, which it is in this case, the system adds node C to the multicasting tree. The cache server C then finds its closest upstream node, which is the content server S completing step 330. The request C1 is then associated to the content server S in step 340, which is shown in FIG. 2 as line 5.

Step 320 is then performed for content server S. According to step 320, since the content server S is on the multicasting tree, the answer is YES and it goes to step 350. Since the current server is the content server, the answer at 350 is NO and it goes to process the next request.

Turning now to request C1, request C1 is generated in step 300 (subsequent to request B1), and associated with the cache server C in step 310. Since the node C was already added to the multicasting tree in performing the process for request B1, the answer at step 320 is YES and process continues to step 350. Since the service time of C1 (8 PM) is later than the service time of B1 (5 PM), the answer to step 350 is NO. The process then starts over and processes the next request.

Turning now to request A1, which was received subsequent to request C1, request A1 is generated in step 300 and associated with the cache server A in step 310. According to step 320 the determination is made whether the cache server A is on the multicasting tree. In this case, the answer is NO and the process continues to step 330. At this point, node A is first added to the multicasting tree and then cache server A finds its upstream cache server B, completing step 330. Request A1 is then associated to the cache server B in step 340. This association is shown in FIG. 2 as line 6. Since node B is already on the multicasting tree and the service time of A1 is later than service time on node B, the answer to step 350 is NO. The process then begins over and processes the next request.

The algorithm used in determining the distance between cache servers is not only based on the geographical distance but also other factors, such as cache capacity, load balance of network links, etc. For example, node A may find node C is its upstream node because the cost of caching the content from 5 PM to 7 PM at node B may be larger than the cost difference between link 7 and link 6.

While the invention has been described and illustrated in sufficient detail that those skilled in this art can readily make and use it, various alternatives, modifications, and improvements should become readily apparent without departing from the spirit and scope of the invention.

1. A method for processing requests for content files from a content delivery network system comprising:
receiving a request for content to be delivered at a service time,
associating the content file with a particular cache server,
dynamically establishing a multicasting tree of cache servers,
associating the request with an upward cache server in the multicasting tree, when the service time is not earlier than already existing service times; and
delivering the requested content at the service time from the multicasting tree of cache servers.

2. The method according to claim 1 wherein the associating step further comprises the step of associating the request with a closest cache server.

3. The method according to claim 1 wherein the dynamically establishing step further comprises the step of adding a cache server associated with a request if the cache server is not already associated with the multicasting tree.

4. The method according to claim 1 wherein the associating step further comprises the step of associating the request with a closest cache server if the request has an earlier service time than previous requests.

5. A method for processing requests for content files from a content delivery network system comprising the steps of:
(a) receiving a first request for a content file having a first service time;
(b) associating the first request with a cache server for retrieval;
(c) determining whether the associated cache server is on a multicasting tree rooted at a content server that is an origin of the content file;
(d) upon determining that the associated cache server is not on the multicasting tree, adding the associated cache server to the multicasting tree, finding an upstream cache server towards the content server, associating the first request with the upstream cache server found so that the upstream cache server becomes the associated cache server, and repeating step (c) until the content server is reached and the first request is associated with the content server, wherein upon the first request being associated with content server, processing a next request for the content file beginning with step (a);
(e) upon determining that the associated cache server is on the multicasting tree, determining whether the first service time is earlier than all service times of requests for the content file that already exist on the associated cache server;
(f) upon determining that the first service time is not earlier than all other service times of requests that already exist on the associated cache server, associating the first request with the cache server and processing the next request for the content file beginning with step (a); and
(g) upon determining that the first service time is earlier than all other service times of requests that already exist on the associated cache server, associating the first request with the cache server that was determined to be the upstream cache server toward the content server in the multicasting tree so that this cache server becomes the associated cache server and returning to step (c) until the first request is associated with the content server, wherein upon the first request being associated with the content server, processing the next request for the content file beginning with step (a).

6. The method of claim 5 wherein the step of finding an upstream cache server comprises finding a closest upstream cache server using request routing procedures.

7. The method of claim 6 wherein closeness is determined using at least one factor selected from the group consisting of geographical distance, cache occupancy, and load balance of network links.

8. The method of claim 5 wherein the step of finding an upstream cache server comprises finding the upstream cache server using a hierarchical relationship.

9. A content delivery network system for processing requests for content files comprising a content server and a CDN network with at least one cache server adapted to (a) receive a first request for a content file from a client, (b) associate the first request with a cache server for retrieval, (c) determine if the associated cache server is on a multicasting tree and if not, associate the cache server to the multicasting tree, and with means for associating the request with an upward cache server in the multicasting tree when the first service time is not earlier than all other service times of requests that already exist on the associated cache server on the multicasting tree.

10. The system of claim 9 having means to determine whether the first service time is earlier than the all other service times of requests that already exist on the associated cache server on the multicasting tree, and if it is not, associate the first request with the cache server which is on the tree, and if it is, find the upstream cache server and associate the first request to the upstream cache server until either the first service time is not earlier than all other service times of requests that already exist on the associated cache server on the multicasting tree or the first request is associated to the content server.

11. The system of claim 9 having means for associating the first request with the cache server that was determined to be on the multicasting tree if the first service time is not earlier than the all other service times of requests that already exist on the associated cache server on the multicasting tree.

12. The system of claim 9 having means for finding a closest upstream cache server by means of request routing.

13. The system of claim 12 having means for finding a closest upstream cache server using at least one factor selected from the group consisting of geographical distance, cache occupancy, and load balance of network links.

14. The system of claim 9 having means for finding an upstream cache server using a hierarchical relationship.

15. The system of claim 9 further including a content delivery network broker which is adapted to provide information for a request routing procedure whose result is to be used by the content server, and the information is regarding the availability of the requested content file on one or more cache servers in a content delivery network.

16. The system of claim 9 further including a content delivery network broker which is adapted to provide information for a request routing procedure whose result is to be used by the content server, and the information is regarding the availability of the requested content file on one or more cache servers in a content delivery network or to schedule the future availability of the content file at one or more cache servers 13.

17. The system of claim 9 further including one or more cache servers and a content delivery network broker and means for the broker, cache servers, and/or content server to determine the future time period and the server from which the client can request the file.
